(19) United States
(12) Patent Application Publication
(10) Pub. No.: US 2025/0231083 A1
(43) Pub. Date: Jul. 17, 2025

(54) MULTIPLE MAGNIFICATION INSPECTION OF DUTS

(71) Applicant: VIAVI SOLUTIONS INC., Chandler, AZ (US)

(72) Inventors: Abhilash SUKUMARI, Nepean (CA); Nicklos Joseph BULITKA, Stittsville (CA); Christopher Russell WAGNER, Kanata (CA); Eugene CHAN, Ottawa (CA); Christian Richard COMTOIS-ARNALDO, Ottawa (CA); Kevin CASSADY, Monroe, WA (US); Jeffery Stephen GRAVES, Oxford Station (CA); Joshua Benjamin Julius PHILIPSON, Ottawa (CA)

(73) Assignee: VIAVI SOLUTIONS INC., Chandler, AZ (US)

(21) Appl. No.: 18/412,079

(22) Filed: Jan. 12, 2024

(51) Int. Cl. G01M 11/00

(52) U.S. Cl. CPC G01M 11/31

(57) ABSTRACT

According to examples, an apparatus for inspecting a device under test (DUT) may include a chassis and an optical system having a camera assembly, a first objective assembly having a first magnification level, and a second objective assembly having a second magnification level. The apparatus may also include a DUT interface including an opening in the chassis through which an end of a DUT inserted into the opening of the DUT interface is selectively visible to one of the first objective assembly and the second objective assembly, in which at least one of the DUT interface and the optical system is movable with respect to the other one of the DUT interface and the optical system.

### TECHNICAL FIELD

The disclosure relates generally to visual inspection apparatuses. Particularly, the disclosure relates to apparatuses that may be employed to visually inspect devices under test (DUTs) under multiple magnification levels, in which the magnification level applied on the DUTs may be switched between the multiple magnification levels. In some examples, the DUTs may be fiber-optic terminating connectors.

### BACKGROUND

Optical fibers are often used to communicate telecommunication signals between sources and destinations because the optical fibers enable relatively high data transmission rates and bandwidths. Optical fibers also experience relatively low signal loss (attenuation) over long distances, which enables telecommunication signals to travel over long distances, oftentimes without requiring the need for frequent signal amplification. The ends of optical fibers, e.g., connectors, are often capped with ferrules to enable coupling of the optical fibers with various types of equipment. In some instances, a microscope may be used to inspect the ends of the optical fibers and connectors.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an apparatus for inspecting a device under test (DUT), such as a terminating end of a fiber-optic cable, according to an example of the present disclosure;

FIG. 2A shows a perspective view of an apparatus for inspecting a DUT, such as a terminating end of a fiber-optic cable, according to an example of the present disclosure;

FIG. 2B shows a side view of a portion of the optical system depicted in FIG. 2A, according to an example of the present disclosure;

FIGS. 3A and 3B, respectively, show cross-sectional top views of an optical system, according to an example of the present disclosure;

FIGS. 3C and 3D, respectively, show cross-sectional top views of an optical system, according to an example of the present disclosure;

FIG. 4A shows a block diagram of an apparatus for inspecting a fiber-optic cable, according to an example of the present disclosure;

FIGS. 4B and 4C respectively, show block diagrams of DUT interfaces 112, according to examples of the present disclosure;

FIG. 5 illustrates a flow diagram of a method for inspecting a DUT, such as a terminating end of a fiber-optic cable, according to an example of the present disclosure; and

FIG. 6 shows a perspective view of an apparatus for inspecting a DUT, according to an example of the present disclosure.

### DETAILED DESCRIPTION

In the following description, numerous specific details are set forth in order to provide a thorough understanding of the present disclosure. It will be readily apparent however, that the present disclosure may be practiced without limitation to these specific details. In other instances, some methods and structures readily understood by one of ordinary skill in the art have not been described in detail so as not to unnecessarily obscure the description of the present disclosure. Also, for simplicity and illustrative purposes, the present disclosure is described below by referring mainly to examples. As used herein, the terms “a” and “an” are intended to denote at least one of a particular element, the term “includes” means includes but not limited to, the term “including” means including but not limited to, and the term “based on” means based at least in part on.

The telecom industry requires the use of millions, if not billions, of fiber-optic cables to communicate data and signals across many millions of devices. The fiber-optic cables should be free of defects as the defects may potentially affect the communication of the data and signals at desired loss and throughput levels. In order to ensure that the fiber-optic cables are free of such defects, the cables typically undergo rigorous visual inspections. Due to the large numbers of cables that are inspected, the telecom industry often struggles with the time and costs associated with the visual inspections of the cables.

An optical fiber microscope is often used to inspect and/or analyze terminating ends of optical fibers in an optical cable. The terminating ends of the optical fibers may be inspected and/or analyzed in order to post-polish certify the optical cable, to identify contamination during various stages of manufacturing and testing (e.g., polarity testing, insertion loss testing, return loss testing, final inspection, etc.), to identify contamination during mechanical (connector body, cassette, cabinet, pedestal) assembly, for final packaging verification, to improve production yields by eliminating costly component damage, etc. Although useful in visually inspecting the terminating ends of the optical cables, use of conventional optical fiber microscopes may be unable to meet certain rapid inspection demands for large volumes of optical cables.

Disclosed herein are apparatuses and methods for automatically inspecting DUTs, e.g., terminating ends of optical fibers, connectors of optical fibers, etc., at multiple magnification levels. Particularly, the apparatuses disclosed herein may include a first objective assembly having a first magnification level and a second objective assembly having a second magnification level. The apparatuses may also include optical pathways to a common imager that are selectively switchable between the first objective assembly and the second objective assembly such that images of a DUT may be captured at either of the magnification levels during respective time periods. In addition, the apparatuses may include features that enable the first objective assembly or the second objective assembly to be positioned in front of the DUT depending upon the magnification level at which images of the DUT are to be captured. The apparatuses may further include DUT interfaces that may enable various types of DUTs and/or multiple DUTs to be positioned for imaging.

The apparatuses may also include controllers that may inspect the images to determine whether the DUT includes sufficient defects to warrant rejecting the DUT as having failed an inspection. According to examples, a controller may execute an inspection process in which images of the DUT captured at a first magnification level are analyzed to determine whether the DUT has passed the inspection. Based on a determination that the DUT has failed the inspection, the controller may stop the inspection and may output an indication that the DUT has failed. However, based on a determination that the DUT has passed the inspection at the first magnification level, the controller may cause the second objective assembly to be positioned such that the imager may capture images of the DUT through the second objective assembly. The controller may analyze the captured images to inspect the DUT at the second magnification level.

Through implementation of the features of the present disclosure, the same imager may capture images of a DUT, e.g., a terminating end of a fiber-optic cable, at multiple magnification levels through multiple objective assemblies. In addition, a common optical pathway may be provided from the multiple objective assemblies and the imager. Moreover, in some examples, the images of the DUT may be captured at the multiple magnification levels without moving the DUT, e.g., the DUT may remain stationary during the inspection of the DUT at the multiple magnification levels. In addition or in other examples, the DUT may be moved while the first and second objective assemblies are moved. A technical improvement afforded through features of the present disclosure may thus include a reduction in a number of parts through use of a common imager for multiple magnification levels. Another technical improvement may be that the length of time consumed in inspecting DUTs may be reduced or minimized by only inspecting images of DUTs captured at a higher magnification level when the DUTs pass inspection at a lower magnification level. A further technical improvement afforded through implementation of the present disclosure may thus be that optical cables may be inspected in an efficient manner.

In other words, the present disclosure may provide cost-effective, portable fiber-optic cable inspection apparatuses that may rapidly inspect fiber-optic cables. In addition, the fiber-optic cable inspection apparatuses disclosed herein may delineate between various types of defects, e.g., whether the defects are mobile particulates, deficient polishes, surface quality, scratches, gouges, or the like, which may result in more accurate inspections of the fiber-optic cables.

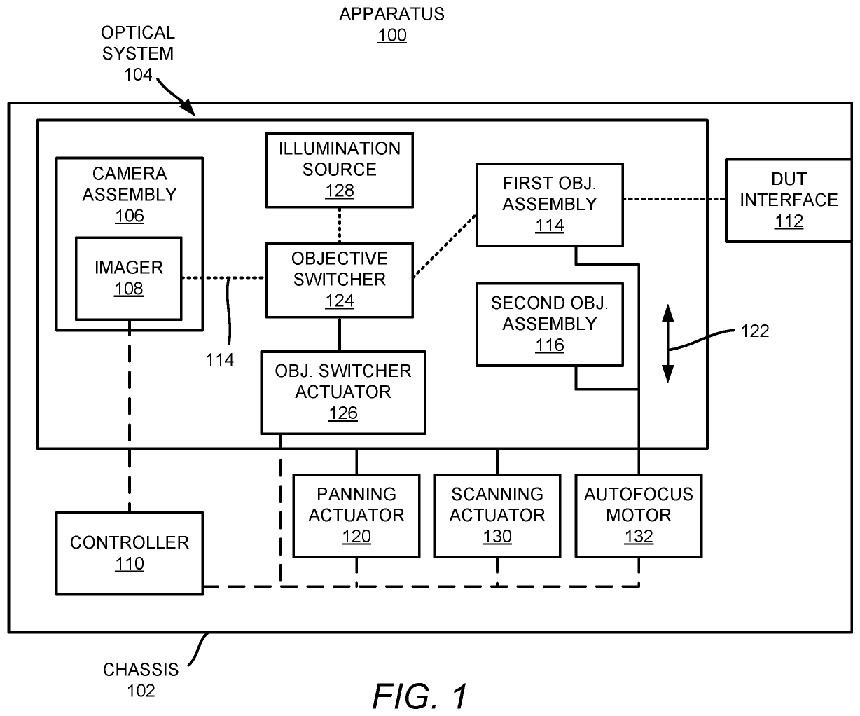

With reference first to FIG. 1, there is shown a block diagram of an apparatus 100 for inspecting a device under test (DUT), such as a terminating end of a fiber-optic cable, according to an example of the present disclosure. It should be understood that the apparatus 100 may include additional features and that some of the features described herein may be removed and/or modified without departing from the scope of the apparatus 100.

The apparatus 100, which may also be termed an optical fiber microscope, may include a microscope (e.g., a table-top microscope or a hand-held microscope) that may be used to analyze DUTs, such as terminating ends of optical fibers. It should be understood that references made herein to an optical fiber should also be construed as being made to an optical cable, a fiber-optic cable, or the like. In any regard, the apparatus 100 may include an optical probe, an optical fiber microscope, a fault locator, an optical fiber inspection microscope, and/or the like.

As shown in FIG. 1, the apparatus 100 may include a chassis 102 that may house an optical system 104. The optical system 104 may include some or all of the components housed in the chassis 102. As shown, the optical system 104 may include a camera assembly 106, which includes an imager 108. The imager 108 may be an electronic device, e.g., a sensor, that may convert incoming light into digital signals. The imager 108 may communicate the digital signals to a controller 110, which may process the digital signals to create digital images. In addition, the controller 110 may analyze the digital images to inspect a DUT. In addition, the controller 110 may determine whether the DUT has passed or failed an inspection, e.g., whether the DUT has a sufficient number of defects or a defect having a sufficient size to warrant failing the inspection. Moreover, the controller 110 may output an indication as to whether the DUT has passed or failed the inspection.

In some examples, the controller 110 may delineate between various types of defects, e.g., whether the defects are mobile particulates, deficient polishes, surface quality, scratches, gouges, or the like. The controller 110 may identify the various types of defects through, for instance, implementation of an image recognition technique. In these examples, the controller 110 may also output the identified type or types of defects.

In some examples, the apparatus 100 may include a DUT interface 112 (also referenced herein as a fiber-optic cable interface 112) positioned on the chassis 102. As discussed in greater detail herein, the DUT interface 112 may include an opening into which a DUT may be inserted and held in position for the imager 108 to capture one or more images of the DUT. In addition, the DUT interface 112 may enable any of a number of various types of DUTs, e.g., various types of fiber-optic cable terminating ends, to be positioned for inspection by the apparatus 100. By way of example, the DUT interface 112 may support the various types of DUTs directly and/or may support multiple types of adapters in which the various types of DUTs may be held. In addition, or alternatively, the DUT interface 112 may concurrently support multiple DUTs.

According to examples, images of the DUT may respectively be captured through multiple objective assemblies 114, 116, in which the objective assemblies 114, 116 may have different magnification levels with respect to each other. That is, images of the DUT may be captured through a first objective assembly 114 during a first time frame and through a second objective assembly 116 during a second time frame such that images of the DUT may be captured at multiple magnification levels. Particularly, during a first time frame, light from the DUT may be directed through the first objective assembly 114 and onto the imager 108. Additionally, during a second time frame, light from the DUT may be directed through the second objective assembly 116 and onto the imager 108. In this regard, the same camera assembly 106 and thus, the same imager 108, may be employed to capture images of the DUT at multiple magnification levels.

The first objective assembly 114 may include a first set of lenses that enable the first objective assembly 114 to have a first magnification level, e.g., to cause images viewed through the first objective assembly 114 to be magnified by a first magnification level. Likewise, the second objective assembly 116 may include a second set of lenses that enable the second objective assembly 116 to have a second magnification level, e.g., to cause images viewed through the second objective assembly 116 to be magnified by a second magnification level. According to examples, the first objective assembly 114 may have a lower magnification level than the second objective assembly 116. By way of particular example, the first magnification level may be a 2× magnification level and the second magnification level may be a 10× magnification level. In other examples, the first magnification level and the second magnification level may be other magnification levels and/or the second objective assembly 116 may differ in another respect from the first objective assembly 114. In still other examples, the apparatus 100 may include one or more other objective assemblies having other magnification levels.

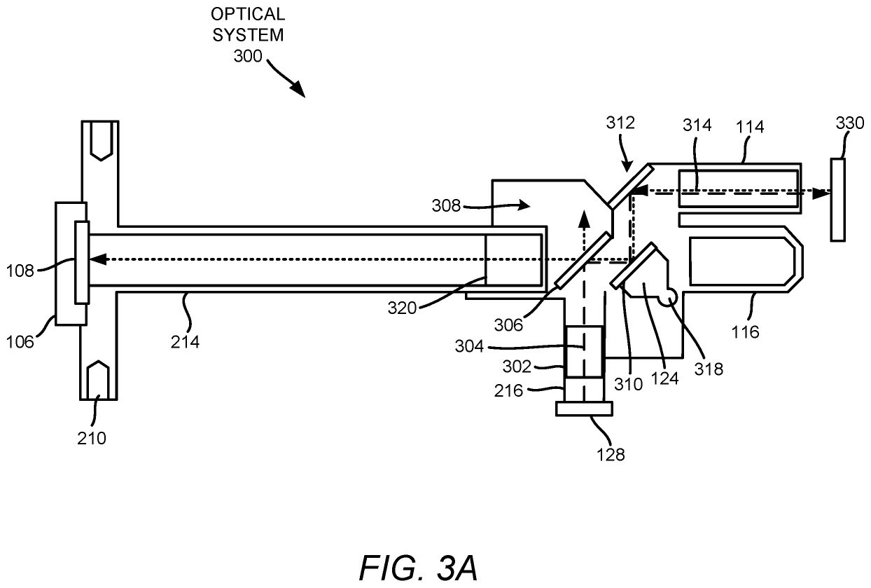

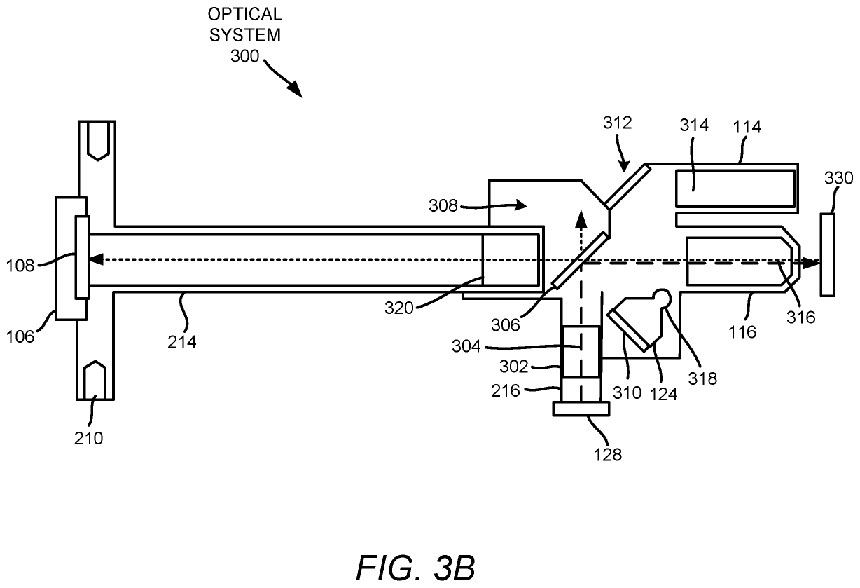

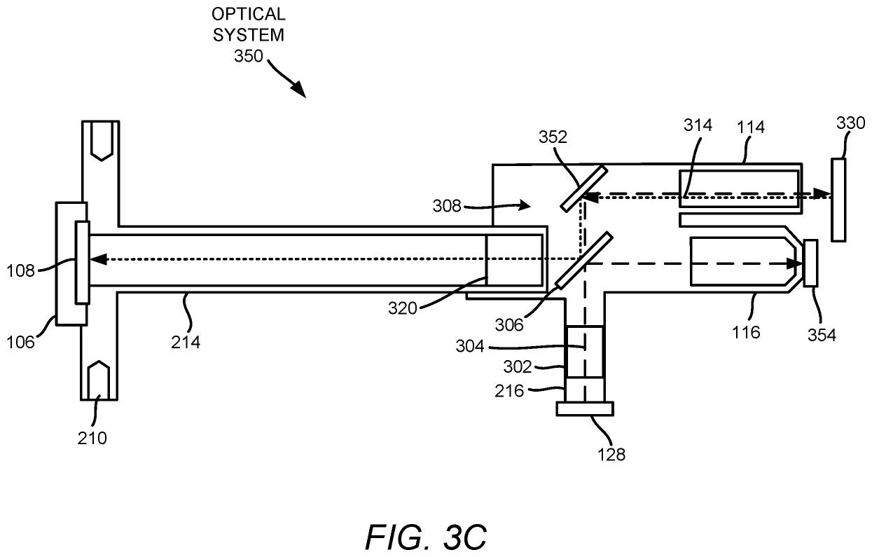

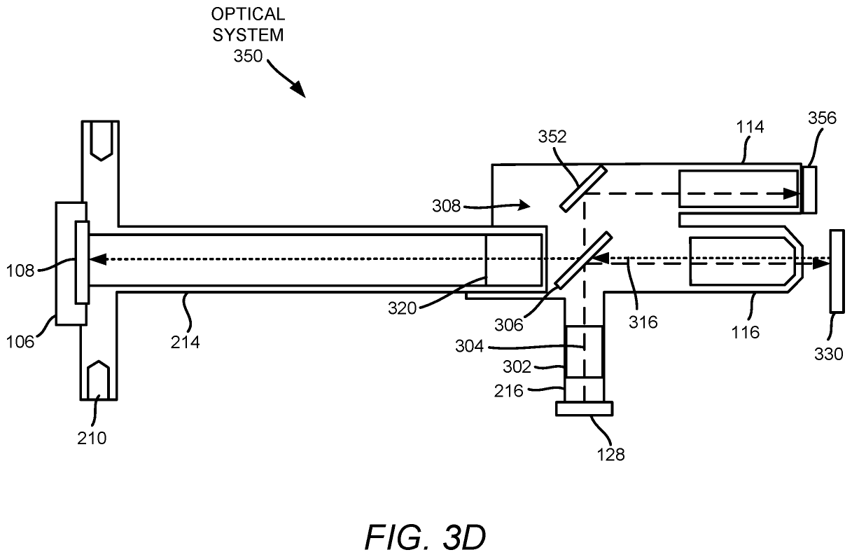

According to examples, the apparatus 100 may include components that may enable optical paths from the DUT interface 112 to the imager 108 to be moved between the first objective assembly 114 and the second objective assembly 116. The components may include a panning actuator 120 that may pan the optical system 104 between a first position in which the first objective assembly 114 is adjacent to (e.g., in front of) the DUT interface 112 and a second position in which the second objective assembly is adjacent to (e.g., in front of) the DUT interface 112. In other words, the panning actuator 120 may move the optical system 104 between a position in which light rays from a DUT in the DUT interface 112 enter into the first objective assembly 114 as shown in FIG. 1 and a position in which light rays from the DUT enter into the second objective assembly 116. The panning movement of the optical system 104 is denoted by the arrow 122 and is discussed in greater detail below with respect to FIGS. 3A and 3B.

In other examples, the panning actuator 120 may pan the DUT interface 112 between a first position in which the DUT interface 112 is adjacent to (e.g., in front of) the first objective assembly 114 and a second position in which the DUT interface 112 is adjacent to (e.g., in front of) the second objective assembly. In other words, the panning actuator 120 may move the optical system 104 between a position in which light rays from a DUT in the DUT interface 112 enter into the first objective assembly 114 as shown in FIG. 1 and a position in which light rays from the DUT enter into the second objective assembly 116. The panning movement of the DUT interface 112 is denoted by the arrow 122.

The components to enable movement of the optical paths from the DUT interface 112 to the imager 108 may also include an objective switcher 124. The objective switcher 124 may selectively be moved between a first arrangement in which light from the first objective assembly 114 is directed to the imager 108 of the camera assembly 106 and a second arrangement in which light from the second objective assembly 116 is directed to the imager 108. That is, for instance, in the first arrangement, the objective switcher 124 may direct light from the first objective assembly 114 to the imager 108 while blocking light from the second objective assembly 116 from being directed to the imager 108. Additionally, in the second arrangement, the objective switcher 124 may be in a position that enables light from the second objective assembly 116 to be directed to the imager 108 without directing light from the first objective assembly 114 to the imager 108.

According to examples, the optical system 104 may include an objective switcher actuator 126 that may control movement of the objective switcher 124. As discussed herein, the objective switcher 124 may be moved between the first arrangement and the second arrangement by rotating from one position to another, by translating horizontally from one position to another, by translating vertically from one position to another, and/or the like. The objective switcher actuator 126 may cause the objective switcher 124 to be moved in the certain manner.

In some examples, the objective switcher 124 may include a reflective surface 310 that may be pulled against a reference surface to set a hard-limit. An adjustable end-stop referenced to this reference surface may be set to calibrate and set the desired angle of that reflective surface 310. In addition, an electrical drive sequence may be employed to step into the hard-limit slowly and controllably and then an overdrive may be applied by some small amount, to ensure that the objective switcher 124 is preload pressed into the hard-limit. Moreover, the mount may be strain relieved.

The optical system 104 may also include an illumination source 128 that may direct light rays toward the DUT interface 112 through one of the first objective assembly 114 and the second objective assembly 116 at a time. The illumination source 128 may be any suitable type of illumination device for an optical system, such as a light emitting diode, an incandescent lamp (such as a tungsten lamp), a halogen lamp, an arc lamp, and/or the like. The position of the objective switcher 124 may determine whether the light rays from the illumination source 128 are directed to the first objective assembly 114 or the second objective assembly 116. For instance, when the objective switcher 124 is in the first arrangement, the light rays from the illumination source 128 may be directed through the first objective assembly 114. Likewise, when the objective switcher 124 is in the second arrangement, the light rays from the illumination source 128 may be directed through the second objective assembly 116.

As shown in FIG. 1, the optical system 104 and the components in the optical system 104 may be positioned such that the light rays from the illumination source 128 are to be directed through the first objective imager 114 and onto a DUT visible through the DUT interface 112. Additionally, light from the DUT may be reflected back through the first objective assembly 114 and the objective switcher 124 may direct the reflected light to the imager 108 such that the imager 108 may capture images of the DUT at a first magnification level.

When images of the DUT are to be captured through the second objective assembly 116, e.g., at a different magnification level, the controller 110 may cause the panning actuator 120 to move the optical system 104 such that the second objective assembly 116 is positioned adjacent to the DUT interface 112. In addition, the controller 110 may cause the objective switcher actuator 126 to move the objective switcher 124 to the second arrangement. By moving the objective switcher 124 to the second arrangement, light rays from the illumination source 128 may be directed through the second objective assembly 116 and toward the DUT interface 112. In addition, light from the DUT may be reflected back through the second objective assembly 116 and to the imager 108, for instance, by bypassing the objective switcher 124. The imager 108 may thus capture images of the DUT at a second magnification level.

In some examples, the objective switcher 124 and the objective switcher actuator 126 may be omitted and instead, light rays may be directed to both the first objective assembly 114 and the second objective assembly 116 concurrently. Instead, the second objective assembly 116 may be blocked and/or light directed through the second objective assembly 116 may be redirected such that the light does not go back through the second objective assembly 116 to the imager 108 when images are to be captured through the first objective assembly 114. Likewise, the first objective assembly 114 may be blocked and/or light directed through the first objective assembly 114 may be redirected such that the light does not go back through the first objective assembly 114 to the imager 108 when images are to be captured through the second objective assembly 116. Examples of this configuration are described herein with respect to FIGS. 3C and 3D.

According to examples, the optical system 104 may include a scanning actuator 130 that may scan the first objective assembly 114 and the second objective assembly 116 vertically with respect to the DUT interface 112. In some examples, the optical system 104 may be mounted on a pivoting axis at a distance away from the first objective assembly 114 and the second objective assembly 116. In these examples, the scanning actuator 130 may cause the optical system 104 to pivot about the pivoting axis, which may cause the first objective assembly 114 and the second objective assembly 116 to move vertically. In other examples, the scanning actuator 130 may cause the optical system 104 to be moved vertically without pivoting about a pivoting axis. In other examples, the scanning actuator 130 may scan the DUT interface 112 with respect to the optical system 104.

In some examples, the DUT interface 112 may support a plurality of DUTs, DUTs having multiple components, or DUTs having a relatively large area. For instance, the DUT may include a plurality of fiber-optic connector termination ends, all of which may not be captured by either or both of the first objective assembly 114 and the second objective assembly 116. In these examples, the controller 110 may cause the scanning actuator 130 to scan the optical system 104 (and/or the DUT interface 112) vertically such that images of multiple horizontally adjacent regions of the DUT may be imaged through either or both of the first objective assembly 114 and the second objective assembly 116. For similar reasons, the controller 110 may cause the panning actuator 120 to move the optical system 104 (and/or the DUT interface 112) slightly such that images of multiple horizontally adjacent regions of the DUT may be imaged through either or both of the first objective assembly 114 and the second objective assembly 116.

As shown in FIG. 1, the apparatus 100 may also include an autofocus motor 132 that may move lenses in the first objective assembly 114 and the second objective assembly 116 with respect to the DUT interface 112. That is, the autofocus motor 132 may move the lenses in the first objective assembly 114 and the second objective assembly 116 with respect to the DUT interface 112 such that the imager 108 may capture images of the DUT at multiple resolution levels. For instance, the imager 108 may continuously capture images of the DUT as the autofocus motor 132 changes the focus. The imager 108 may send data corresponding to the continuously captured images to the controller 110 and the controller 110 may inspect the DUT using the received data. By way of example, the controller 110 may use the data corresponding to the clearest images to inspect the DUT.

According to examples, the autofocus motor 132 may drive both the first and second objective assemblies 114, 116 at the same time through use of, for instance, a floating mount. This is possible by virtue of the optical systems 104 disclosed herein having an infinity conjugated design. By driving the first and second objective assemblies 114, 116 concurrently, the mechanical mass that is to be moved may be minimized, which may enable high-speed autofocus. In addition, by locking both the first and second objective assemblies 114, 116 mechanically referenced together, the parfocality of the infinity conjugated design may be preserved.

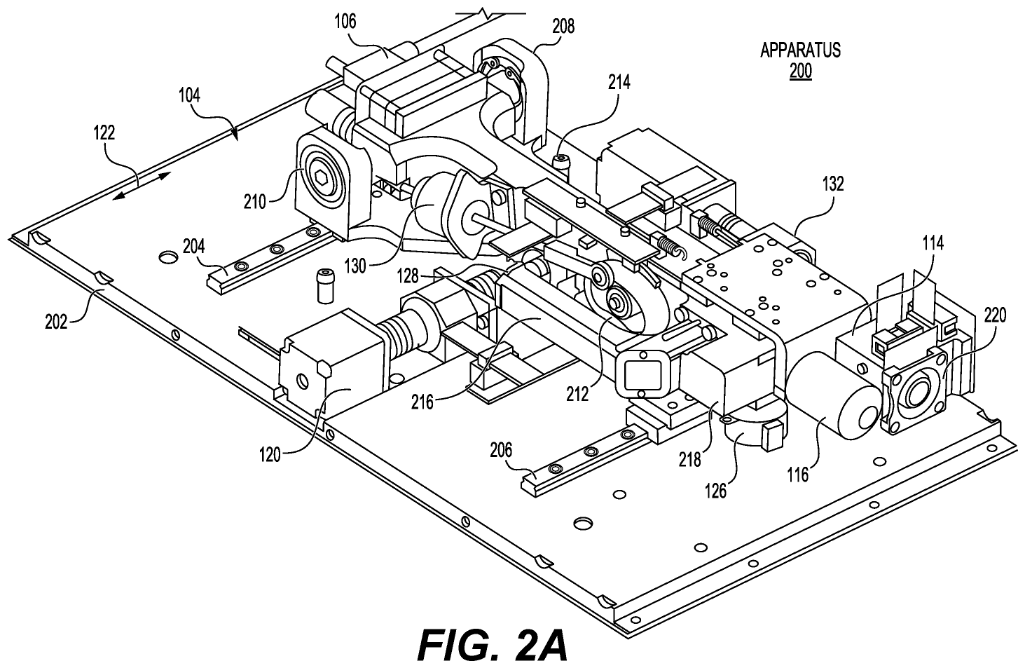

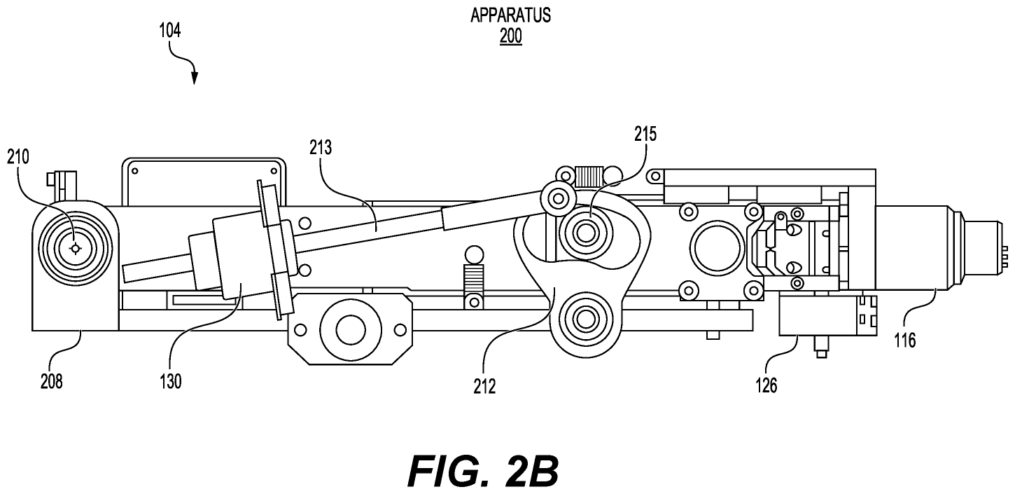

FIG. 2A shows a perspective view of an apparatus 200 for inspecting a DUT, such as a terminating end of a fiber-optic cable, according to an example of the present disclosure. It should be understood that the apparatus 200 may include additional features and that some of the features described herein may be removed and/or modified without departing from the scope of the apparatus 200.

As shown in FIG. 2A, the apparatus 200 may include some or all of the components of the apparatus 100 depicted in FIG. 1. In one regard, the apparatus 200 may be an example configuration of the apparatus 100 shown in FIG. 1. Although not shown in FIG. 2A, the apparatus 200 may include a chassis 102 that houses the components shown in FIG. 2A as discussed with respect to FIG. 1.

The apparatus 200 may include an optical system 104, which may include a camera assembly 106, a first objective assembly 114, a second objective assembly 116, a panning actuator 120, a scanning actuator 130, and an autofocus motor 132. The apparatus 200 may also include a base 202 on which these components are supported. The base 202 may include a pair of rails 204, 206 upon which the optical system 104 may movably be supported. In this regard, actuation of the panning actuator 120 may cause the optical system 104 to move along the rails 204, 206 in the directions indicated by the arrow 122.

The apparatus 200 may also include a scanning base 208 that may provide a pivot axis 210 about which the optical system 104 may rotate. An example of a manner in which the optical system 104 may rotate about a pivot axis 210 is shown in FIG. 2B. Particularly, FIG. 2B shows a side view of a portion of the optical system 104 depicted in FIG. 2A, according to an example of the present disclosure. As shown in FIGS. 2A and 2B, the optical system 104 may include the scanning actuator 130 that may rotate the optical system 104 about the pivot axis 210, thus moving the vertical positions of the first objective assembly 114 and the second objective assembly 116. As a result, the first objective assembly 114 and the second objective assembly 116 may be moved to image multiple vertical positions on a DUT, e.g., to scan multiple rows of features on a DUT.

In the example shown in FIGS. 2A and 2B, the scanning actuator 130 may be connected to a cam-based scanning mechanism 212 through a rod 213. Particularly, actuation of the scanning actuator 130 may cause the rod 213 to move laterally, which may cause the cam-based scanning mechanism 212 to be moved with respect to a member 215 connected to a section of the optical system 104. The cam-based scanning mechanism 212 may have a shape that may enable the member 215 to be raised or lowered depending upon the position of the cam-based scanning mechanism 212. By raising the member 215, the optical system 104 may be rotated about the pivot axis 210 causing the first objective assembly 114 and the second objective assembly 116 to be raised above the base 202. In other examples, the optical system 104 may be raised or lowered in other manners, for instance, through use of hydraulics, vertically instead of rotationally, etc.

With reference back to FIG. 2A, the apparatus 200 may further include a collection tube 214 through which light rays from the first objective assembly 114 and the second objective assembly 116 may be directed to the camera assembly 106. The apparatus 200 may still further include an illumination tube 216 through which light rays from an illumination source 128 may be directed to the first objective assembly 114 and the second objective assembly 116. The apparatus 200 is also shown as including an objective switcher actuator 126 positioned to actuate an objective switcher 124 positioned within a housing 218 of the optical system 104.

According to examples, the apparatus 200 may include an external ring light 220 that may be positioned to provide additional light onto a DUT being imaged through the first objective assembly 114. The external ring light 220 may provide oblique lighting onto the DUT such that the imager 108 may better capture images of the DUT and particles and/or defects on the DUT.

FIGS. 3A and 3B, respectively, show cross-sectional top views of an optical system 300 according to an example of the present disclosure. It should be understood that the optical system 300 may include additional features and that some of the features described herein may be removed and/or modified without departing from the scope of the optical system 300. In some examples, the optical system 300 may be similar or equivalent to the optical system 104 depicted in FIGS. 1, 2A, and 2B.

As shown in FIGS. 3A and 3B, the optical system 300 may include some or all of the components of the optical systems 104 depicted in FIGS. 1, 2A, and 2B. In one regard, the optical system 300 may provide a more detailed depiction of the optical system 104 depicted in FIG. 1 according to an example. In addition, FIG. 3A depicts the components of the optical systems 104, 300 in which the objective switcher 124 is in a first arrangement to cause light from the illumination source 128 to be directed to the first objective assembly 114 and light from the first objective assembly 114 to be directed to the imager 108. FIG. 3B depicts the components of the optical systems 104, 300 in which the objective switcher 124 is in a second arrangement to cause light from the illumination source 128 to be directed to the second objective assembly 116 and light from the second objective assembly 116 to be directed to the imager 108.

As shown FIGS. 3A and 3B, the illumination source 128 may be positioned at an end of the illumination tube 216 and may direct light rays (represented by the dashed lines 304) into the illumination tube 216. A collection of lenses (represented by the reference numeral 302) may be positioned within the illumination tube 216, in which the lenses 302 may act on the light rays 304, such as by condensing and/or collimating the light rays. In addition, a beam splitter 306 may be positioned in the light path from the illumination source 128 to the first objective assembly 114 and the second objective assembly 116. The beam splitter 306 may reflect some of the light rays 304 that hit the beam splitter 306 and may allow some of the light rays 304 that hit the beam splitter 306 to pass through the beam splitter 306. In some examples, the beam splitter 306 may be a 50/50 beam splitter that may reflect 50% of the light rays 304 and may allow 50% of the light rays 304 to pass through the beam splitter 306. In other examples, the beam splitter 306 may reflect and pass through different levels of light rays with respect to each other.

According to examples, the optical system 104 may include a beam dump 308 located behind the beam splitter 306. Particularly, the beam dump 308 may be located in an area behind the beam splitter 306 such that the light rays 304 that pass through the beam splitter 306 may go into the beam dump 308. The beam dump 308 may include a coating or may otherwise be engineered to absorb or otherwise prevent the light that enters into the beam dump 308 from being directed back through the beam splitter 306 or to other areas outside of the beam dump 308. In other words, the beam dump 308 may prevent the light rays 304 entering into the beam dump 308 from interfering with light directed to the imager 108.

In FIG. 3A, the light rays 304 reflected from the beam splitter 306 may be directed to the objective switcher 124. The objective switcher 124 may include a reflective surface 310 that may direct the light rays 304 toward a reflective surface 312, which may direct the reflected light rays 304 toward the first objective assembly 114. The light rays 304 may go through the first objective assembly 114 and onto a DUT 330 positioned adjacent to the first objective assembly 114.

According to examples, the collection of lenses 302 in the illumination tube 216 may collimate the light rays 304 and may focus an image of the illumination source 128 to be coincident with the back focal plane of the first objective assembly 114. In addition, the first objective assembly 114 may collimate the light rays 304 such that the resulting illumination pencil is incident on the DUT. As a result, the optical system 104 may enable Kohler illumination to be achieved on the DUT through the first objective assembly 114. In other words, various angular pencils of illumination may be overlapped as they are cast upon the DUT, resulting in no illumination source 128 structure on the DUT, and uniform illumination across the field of view of the first objective assembly 114.

In addition, the light rays 304 may reflect from the DUT and may be directed back into the optical system 104 through the first objective assembly 114. The reflective surface 312 may reflect the light rays reflected from the DUT (represented by the dotted lines 314) toward the reflective surface 310 of the objective switcher 124. In addition, the reflective surface 310 may direct the light rays 314 toward the beam splitter 306, which may allow some of the light rays 314 to pass through the beam splitter 306, into the collection tube 214, and to the imager 108. The beam splitter 306 may also reflect some of the light rays 314 toward the illumination tube 216.

According to examples, the illumination tube 216 may include lenses (represented by reference numeral 320). The lenses 320, along with either of the first objective assembly 114 and the second objective assembly 116, may enable the optical system 104 to operate as an infinity conjugated optical microscope regardless of whether images are being captured through the first objective assembly 114 or the second objective assembly 116.

The imager 108 may convert the received light rays 314 into digital signals and may communicate the digital signals to the controller 110. The controller 110 may thus access digital signals corresponding to images of the DUT captured at a first magnification level through the first objective assembly 114. In some examples, the controller 110 may cause the autofocus motor 132 to change the focus of the first objective assembly 114 and the imager 108 may capture images of the DUT at multiple focus levels. For instance, the imager 108 may continuously capture images of the DUT as the focus of the first objective assembly 114 is changed.

In FIG. 3B, as the objective switcher 124 is in the second arrangement, the light rays 304 reflected from the beam splitter 306 may be directed to the second objective assembly 116. The light rays 304 may go through the second objective assembly 116 and onto a DUT 330 positioned adjacent to the second objective assembly 116. For instance, the controller 110 may have caused the panning actuator 120 to pan the optical system 104 with respect to the DUT interface 112 such that the second objective assembly 116 is positioned adjacent to the DUT interface 112. In other words, the second objective assembly 116 may be positioned such that light rays reflected from a DUT in the DUT interface 112 may be captured through the second objective assembly 116.

According to examples, the collection of lenses 302 in the illumination tube 216 may collimate the light rays 304 and may focus an image of the illumination source 128 to be coincident with the back focal plane of the second objective assembly 116. In addition, the second objective assembly 116 may collimate the light rays 304 such that the resulting illumination pencil is incident on the DUT. As a result, the optical system 104 may enable Kohler illumination to be achieved on the DUT through the second objective assembly 116. In other words, various angular pencils of illumination may be overlapped as they are cast upon the DUT, resulting in no illumination source 128 structure on the DUT, and uniform illumination across the field of view of the second objective assembly 116.

The light rays 304 may reflect from the DUT and may be directed back through the second objective assembly 116 (represented by the dotted lines 316) toward the beam splitter 306, which may allow some of the light rays 316 to pass through the beam splitter 306 and the collection tube 214 and to the imager 108. The beam splitter 306 may reflect some of the light rays 314 toward the illumination tube 216.

The imager 108 may convert the received light rays 316 into digital signals and may communicate the digital signals to the controller 110. The controller 110 may thus access digital signals corresponding to images of the DUT captured at a second magnification level through the second objective assembly 116. In some examples, the controller 110 may cause the autofocus motor 132 to change the focus of the second objective assembly 116 and the imager 108 may capture images of the DUT at multiple focus levels. For instance, the imager 108 may continuously capture images of the DUT as the focus of the second objective assembly 116 is changed.

As shown in FIGS. 3A and 3B, the objective switcher 124 may be rotatable about a pivot axis 318 to move between the first arrangement and the second arrangement. In other examples, the objective switcher 124 may be movable in other manners. For instance, the objective switcher 124 may be moved laterally between the first arrangement and the second arrangement, e.g., moved toward or away from the reflective surface 312. In another example, the objective switcher 124 may be moved vertically with respect to the plane of FIGS. 3A and 3B. In still other examples, the objective switcher 124 may be moved in a combination of directions, e.g., both laterally and rotationally.

According to examples, the optical system 104 may be positioned as shown in FIG. 3A when an image of a DUT at the first magnification level is to be captured. In other words, when an image of a DUT is to be captured through the first objective assembly 114. Likewise, the optical system 104 may be positioned as shown in FIG. 3B when an image of a DUT at the second magnification level is to be captured. In other words, when an image of a DUT is to be captured through the second objective assembly 116. In some examples, a user may instruct the controller 110 to position the optical system 104 as shown in FIG. 3A or FIG. 3B depending upon whether the DUT is to be imaged at the first magnification level or the second magnification level.

FIGS. 3C and 3D, respectively, show cross-sectional top views of an optical system 350, according to an example of the present disclosure. It should be understood that the optical system 350 may include additional features and that some of the features described herein may be removed and/or modified without departing from the scope of the optical system 350.

The optical system 350 shown in FIGS. 3C and 3D may be similar or equivalent to the optical system 104 depicted in FIGS. 1, 2A, and 2B. The optical system 350 may thus include some of the components of the optical systems 104, 300 depicted in FIGS. 1-3B and elements having common reference numerals may be the same elements. Detailed descriptions of those common elements are not repeated with respect to FIGS. 3C and 3D for brevity.

The optical system 350 depicted in FIGS. 3C and 3D differs from the optical system 300 depicted in FIGS. 3A and 3B in that the optical system 350 may not include an objective switcher 124 to selectively switch between the first and second objective assemblies 114, 116. Instead, as shown in FIGS. 3C and 3D, the optical system 350 may include a reflective surface 352 positioned behind the beam splitter 306. Particularly, the reflective surface 352 may be positioned such that light rays 304 from the illumination source 128 that pass through the beam splitter 306 may be directed onto the reflective surface 352. In addition, the reflective surface 352 may direct the light rays 304 through the first objective assembly 114. Moreover, light rays 304 that the beam splitter 306 reflects may be directed through the second objective assembly 116.

As shown in FIG. 3C, the light rays 304 that are directed through the first objective assembly 114 may impinge upon a DUT 330 such that images of the DUT 330 may be captured at a first magnification level. In addition, a first blocking/deflecting element 354 or other element that may block, deflect, redirect, and/or otherwise prevent light from the beam splitter 306 from being reflected back toward the imager 108 through the second objective assembly 116, may be positioned at the end of the second objective assembly 116. As a result, only light reflected from the DUT 330 (as represented by the reference numeral 314) may be directed back through the first objective assembly 114 and to the imager 108.

In contrast, as shown in FIG. 3D, the DUT 330 may be positioned to be imaged through the second objective assembly 116 and a second blocking/deflecting element 356 or other element that may block, deflect, redirect, and/or otherwise prevent light from the beam splitter 306 from being reflected back toward the imager 108 through the first objective assembly 114, may be positioned at the end of the first objective assembly 114. As a result, only light reflected from the DUT 330 (as represented by the reference numeral 316) may be directed back through the second objective assembly 116 and to the imager 108. According to examples, the first blocking/deflecting element 354 and/or the second blocking/deflecting element 356 may include a non-reflective surface and/or may be formed of a light-absorbing material. For instance, the first blocking/deflecting element 354 and/or the second blocking/deflecting element 356 may include a coating or may otherwise be engineered to absorb or otherwise prevent the light directed from the beam splitter 306 from being directed back to the beam splitter 306 through one of the first objective assembly 114 or the second objective assembly 116.

In some examples, instead of being positioned the end of the second objective assembly 116, the first blocking/deflecting element 354 may be positioned between the beam splitter 306 and the second objective assembly 116. Likewise, instead of being positioned the end of the first objective assembly 114, the second blocking/deflecting element 356 may be positioned between the beam splitter 306 and the first objective assembly 114.

According to examples, the first blocking/deflecting element 354 may automatically be positioned to block light from being reflected back through the second objective assembly 116 when the DUT 330 is to be imaged through the first objective assembly 114. Likewise, the second blocking/deflecting element 356 may automatically be positioned to block light from being reflected back through the first objective assembly 114 when the DUT 330 is to be imaged through the second objective assembly 116. For instance, the panning actuator 120 may pan the optical system 350 between the two positions and the first and second blocking/deflecting elements 354, 456 may automatically block the respective ones of first objective assembly 114 and the second objective assembly 116. In addition, the blocking/deflecting elements 354, 356 may move vertically with the first and second objective assemblies 114, 116 when, for instance, the scanning actuator 130 move the optical system 350 vertically.

In some examples, the optical system 350 may include motorized actuators (not shown) that may move the first and second blocking/deflecting elements 354, 356 into and out of their respective blocking/deflecting positions. In other examples, an operator may manually move the first and second blocking/deflecting elements 354, 356 into and out of the blocking/deflecting positions. For instance, the actuators may cause either or both of the first and second blocking/deflecting elements 354, 356 to be rotated into and out of a blocking/deflecting position, translated horizontally and/or vertically into and out of a blocking/deflecting position, and/or the like.

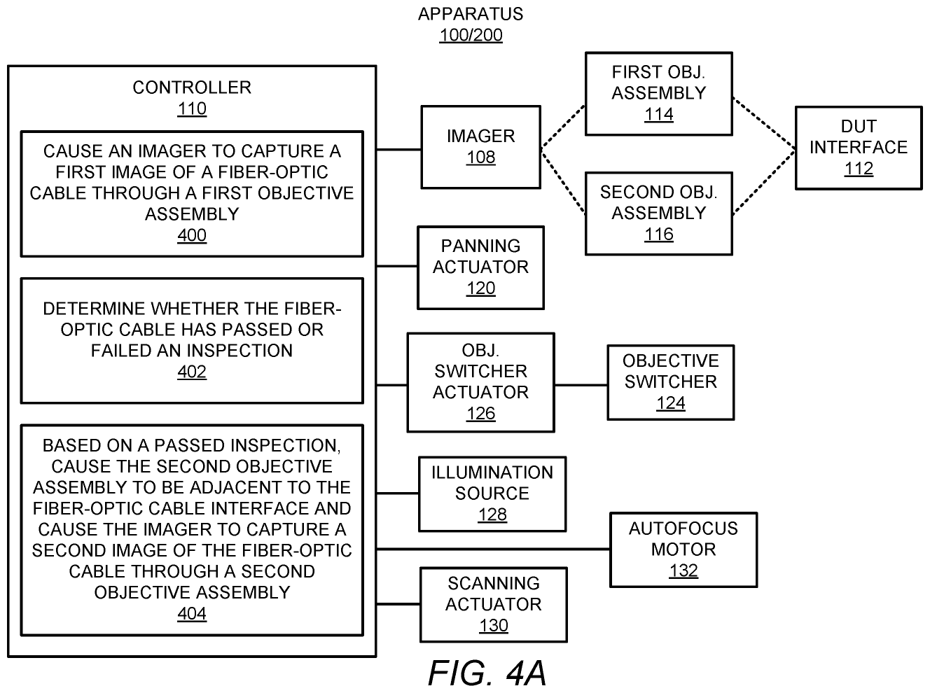

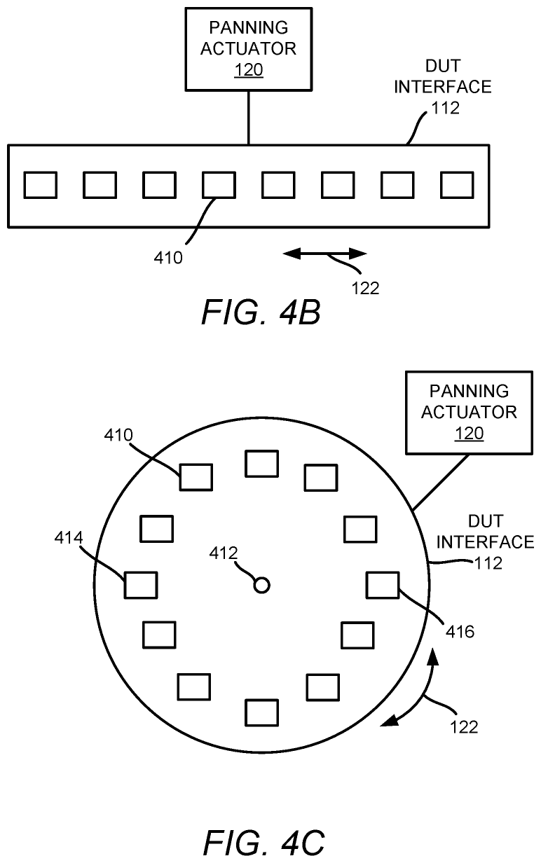

FIG. 4A shows a block diagram of an apparatus 100/200 for inspecting a fiber-optic cable, according to an example of the present disclosure. It should be understood that the apparatus 100/200 may include additional features and that some of the features described herein may be removed and/or modified without departing from the scope of the apparatus 100/200. The apparatus 100/200 may include some or all of the features discussed above with respect to the apparatuses 100, 200 and the optical systems 300, 350 depicted in FIGS. 1-3D. In this regard, like reference numerals in FIGS. 1-4A may refer to common elements in the figures.

As shown in FIG. 4A, the apparatus 100/200 may include a controller 110 that may control operations of components of the apparatus 100/200. The controller 110 may be a semiconductor-based microprocessor, a central processing unit (CPU), an application specific integrated circuit (ASIC), a field-programmable gate array (FPGA), and/or other hardware device. In particular examples, the controller 110 is an FPGA. In some examples in which the controller 110 is a microprocessor or a CPU, the controller 110 may access or may include a memory (not shown), which may also be termed a computer readable medium. In these examples, the memory may be, for example, a Random Access memory (RAM), an Electrically Erasable Programmable Read-Only Memory (EEPROM), a storage device, or the like. In some examples, the memory is a non-transitory computer readable storage medium, where the term “non-transitory” does not encompass transitory propagating signals. In addition, the memory may have stored thereon machine-readable instructions that the controller 110 may execute.

The controller 110 may execute a set of instructions 400-404 that may be employed to inspect a DUT 330, e.g., a terminating end of a fiber-optic cable. The controller 110 may be programmed with the instructions 400-404 and/or the instructions 400-404 may be stored on a memory that the controller 110 may access.

In any of these examples, the controller 110 may cause 400 the imager 108 to capture a first image of the terminating end of the fiber-optic cable through the first objective assembly 114. Particularly, for instance, a user may have inserted a terminating end of the fiber-optic cable through the DUT interface 112 such that the end of the fiber-optic cable may be visible to the imager 108. In addition, the optical system 104 may be positioned such that the first objective assembly 114 may be positioned adjacent to the DUT interface 112 and the objective switcher 124 may be in a first arrangement as shown in FIGS. 3A and 3C and discussed above. Moreover, as also shown in FIGS. 3A and 3C, the controller 110 may have caused the illumination source 128 to be activated such that illumination light may be projected onto the terminating end of the fiber-optic cable through the first objective assembly 114. Light rays 314 reflected from the fiber-optic cable may be directed to the imager 108 through the first objective assembly 114 as discussed above with respect to FIGS. 3A and 3C.

In some examples, the controller 110 may cause the autofocus motor 132 to vary the focus of the first objective assembly 114 and the imager 108 may continuously capture images of the end of the fiber-optic cable at various focus levels. The imager 108 may also forward digital signals corresponding to the captured images to the controller 110, and the controller 110 may analyze the digital signals to identify, for instance, the clearest images of the end of the fiber-optic cable, e.g., images having the highest resolution. In addition, the controller 110 may analyze the clearest images to identify defects in or on the fiber-optic cable end. The defects may include, for instance, gouges in the fiber-optic cable end, geometric imperfections, broken sections, etc. In other words, as the first objective assembly 114 may have a lower magnification level than the second objective assembly 116, the images captured through the first objective assembly 114 may provide a lower level of detail than the images captured through the second objective assembly 116 and thus, the controller 110 may identify larger defects in the fiber-optic cable end from the images captured through the first object assembly 114. The controller 110 may also identify the types of the defects in the captured images.

In addition, the controller 110 may determine 402, from the images, whether the fiber-optic cable has passed or failed an inspection. For instance, the controller 110 may determine whether any defects were identified in the images captured through the first objective assembly 114. In some examples, the controller 110 may determine that the fiber-optic cable has failed the inspection when the controller 110 determines that the images show a defect. In some examples, the controller 110 may determine whether the defect exceeds a predefined threshold, e.g., a size threshold, a count threshold, a position threshold, and/or the like. In these examples, the controller 110 may determine that the fiber-optic cable has failed the inspection when the controller 110 determines that the defect exceeds the predefined threshold. The predefined threshold may be user-defined and may be based on historical data, testing, modelling, ad/or the like.

In other examples, the controller 110 may present the images to a user and the user may determine whether the fiber-optic cable end has a defect that may warrant failing the inspection. In addition, the user may instruct the controller 110 as to whether the fiber-optic cable has passed or failed the inspection at the second magnification level.

In instances in which the fiber-optic cable has been determined as having failed the inspection, the inspection may end and the fiber-optic cable may be identified as being defective. In addition, the inspection of the fiber-optic cable may end without proceeding with inspection of the fiber-optic cable end at the second, greater, magnification level.

In instances in which the fiber-optic cable has been determined as having passed the inspection, the controller 110 may cause 404 the panning actuator 120 to position the second objective assembly 116 to be adjacent to the fiber-optic cable interface 112. For instance, the controller 110 may output a drive signal to the panning actuator 120 to cause the optical system 104, 300, 350 to be moved laterally such that the second objective assembly 116 is positioned to receive light reflected from the fiber-optic cable end. As another example, the controller 110 may output a drive signal to the panning actuator 120 to cause the DUT interface 112 to be moved such that the DUT interface 112 is positioned in front of the second objective assembly 116. In addition, the controller 110 may cause the imager 108 to capture images through the second objective assembly 116.

As discussed herein with respect to FIGS. 3A and 3B, in one example, the controller 110 may cause the objective switcher 124 to be moved to a second arrangement in which the imager 108 is to capture images through the second objective assembly 116. For instance, the controller 110 may output a drive signal to the objective switcher actuator 126 to cause the objective switcher actuator 126 to move the objective switcher 124 to the second arrangement, for instance, as shown in FIG. 3B.

The controller 110 may also output a drive signal to the illumination source 128 to output light rays 304, which, because the objective switcher 124 is in the second arrangement, may be directed through the second objective assembly 116 as shown in FIG. 3B. In addition, some of the light rays 316 that are reflected from the fiber-optic cable end may be directed through the second objective assembly 116 and to the imager 108 as also shown in FIG. 3B.

Alternatively, as discussed herein with respect to FIGS. 3C and 3D, in another example, the controller 110 may cause the second blocking/deflecting element 356 to prevent light from being directed back through the first objective assembly 114 and the first blocking/deflecting element 354 to be moved to a position in which light is directed back through the second objective assembly 116 from the DUT 330. The controller 110 may also output a drive signal to the illumination source 128 to output light rays 304, which may be directed through the second objective assembly 116 as shown in FIG. 3D. In addition, some of the light rays 316 that are reflected from the fiber-optic cable end may be directed through the second objective assembly 116 and to the imager 108 as also shown in FIG. 3D.

In any of the examples, the imager 108 may convert the light rays 316 received from the second objective assembly 116 into digital signals and may communicate the digital signals to the controller 110. As the second objective assembly 116 may have a second, greater, magnification than the first objective assembly 114, the images of the fiber-optic cable end may be at a greater magnification level than the images captured through the first objective assembly 114. As a result, smaller defects, such as dust contamination, scratches, debris, etc., on or in the fiber-optic cable end may be identified from the images.

In addition, the controller 110 may determine, from the images captured at the higher magnification level through the second objective assembly 116, whether the fiber-optic cable has passed or failed the inspection. For instance, the controller 110 may determine whether any defects were identified in the images captured through the second objective assembly 116. In some examples, the controller 110 may determine that the fiber-optic cable has failed the inspection when the controller 110 determines that the images captured through the second objective assembly 116 show a defect. In some examples, the controller 110 may determine whether the defect exceeds a predefined threshold, e.g., a size threshold, a count threshold, a position threshold, and/or the like. In these examples, the controller 110 may determine that the fiber-optic cable has failed the inspection when the controller 110 determines that the defect exceeds the predefined threshold. The predefined threshold may be user-defined and may be based on historical data, testing, modelling, ad/or the like.

In other examples, the controller 110 may present the images to a user and the user may determine whether the fiber-optic cable end has a defect that may warrant the fiber-optic cable end failing the inspection. In addition, the user may instruct the controller 110 as to whether the fiber-optic cable has passed or failed the inspection at the second magnification level.

In instances in which the fiber-optic cable has been determined as having failed the inspection, the inspection may end and the fiber-optic cable may be identified as being defective. In addition, the controller 110 may output an indication that the fiber-optic cable has been identified as being defective. However, in instances in which the fiber-optic cable has been determined as having passed the inspection, the controller 110 may output an indication that the fiber-optic cable has been identified as having passed the inspection.

According to examples, the fiber-optic cable end may be inspected at the lower magnification level prior to inspecting the fiber-optic cable end at the higher magnification level to determine whether the fiber-optic cable end has a relatively large defect. If so, the fiber-optic cable end may not be inspected at the higher magnification level. By omitting continued inspections at higher magnification levels of fiber-optic cable ends having relatively large defects, the lengths of time consumed in inspecting the fiber-optic cable ends may be reduced or minimized.

The DUT interface 112, e.g., the fiber-optic cable end interface 112, may support any of a number of different types of fiber-optic cables. For instance, the DUT interface 112 may support fiber-optic cables having a first type of optical fiber connector, e.g., a simplex connector, having a second type of optical fiber connector, e.g., a duplex connector, having a third type of optical fiber connector, e.g., a multi-fiber push on connector (MPO), a multi-row MPO, and/or the like. In some examples, the DUT interface 112 may include features that enable adapter plates (not shown) configured to receive respective types of optical fiber connectors to replaceably be mounted on the outside of the DUT interface 112. The adapter plates may hold the different types of optical fiber connectors in positions to be imaged through one of the first objective assembly 114 and the second objective assembly 116, respectively. In addition, some adapter plates may enable ends of multiple fiber-optic cables to be held in the DUT interface 112 such that multiple fiber-optic cables may be inspected concurrently.

In some examples, such as when the fiber-optic cable includes an MPO and/or when multiple fiber-optic cable ends are positioned in the DUT interface 112 for inspection, the entire end or all of the fiber-optic cable ends may not be visible through the first objective assembly 114 or the second objective assembly 116. In these examples, the controller 110 may cause the panning actuator 120 to pan the optical system 104 (and/or the DUT interface 112), e.g., horizontally, such that multiple areas of one or more fiber-optic cable ends may be imaged. In addition, or alternatively, the controller 110 may cause the scanning actuator 130 to scan the optical system 104 (and/or the DUT interface 112), e.g., vertically, such that multiple areas of one or more fiber-optic cable ends may be imaged. In some examples, the controller 110 may stitch the multiple images together to generate a more complete image of the one or more fiber-optic cable ends, which may be used to identify defects in the one or more fiber-optic cable ends.

FIGS. 4B and 4C, respectively, show block diagrams of DUT interfaces 112, according to examples of the present disclosure. The DUT interfaces 112 depicted in FIGS. 4B and 4C may be equivalent to and may replace the DUT interfaces 112 shown in FIGS. 1-4A. It should be understood that the DUT interfaces 112 may include additional features and that some of the features described herein may be removed and/or modified without departing from the scopes of the DUT interfaces 112 depicted in FIGS. 4B and 4C.

As shown in FIG. 4B, the DUT interface 112 may include a plurality of connections 410 that may be arranged substantially linearly along a length of the DUT interface 112. In these examples, multiple DUTs may be inserted into the connections 410 and the panning actuator 120 may move the DUT interface 112 linearly as represented by the arrow 122 such that respective ones of the DUTs may be positioned to be imaged through one of the first objective assembly 114 and the second objective assembly 116. In other examples, the panning actuator 120 may move the optical system 104 linearly as represented by the arrow 122 to achieve the same results.

As shown in FIG. 4C, the DUT interface 112 may include a plurality of connections 410 arranged in a substantially circular configuration with respect to each other. In these examples, multiple DUTs may be inserted into the connections 410 and the panning actuator 120 may cause the DUT interface 112 to be rotated around a central axis 412 of the DUT interface 112 as represented by the arrow 122 such that respective ones of the DUTs may be positioned to be imaged through one of the first objective assembly 114 and the second objective assembly 116. In other examples, the panning actuator 120 may rotate the optical system 104 as represented by the arrow 122 to achieve the same results. In some examples, a first connection 414 may be positioned to be imaged through the first objective assembly 114 while a second connection 416 is positioned to be imaged through the second objective assembly 116.

In some examples, the panning actuator 120 may be omitted operations of the panning actuator 120 may be overridden by a user. In these examples, a user may manually move or rotate the DUT interface 112 such that a selected one of the connections 410 is positioned to be imaged through one of the first objective assembly 114 and the second objective assembly 116.

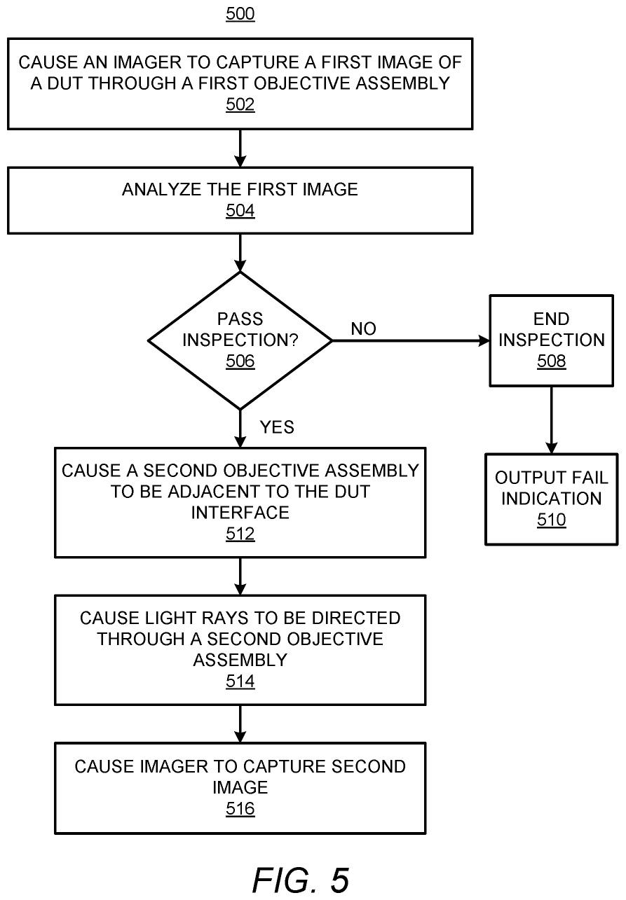

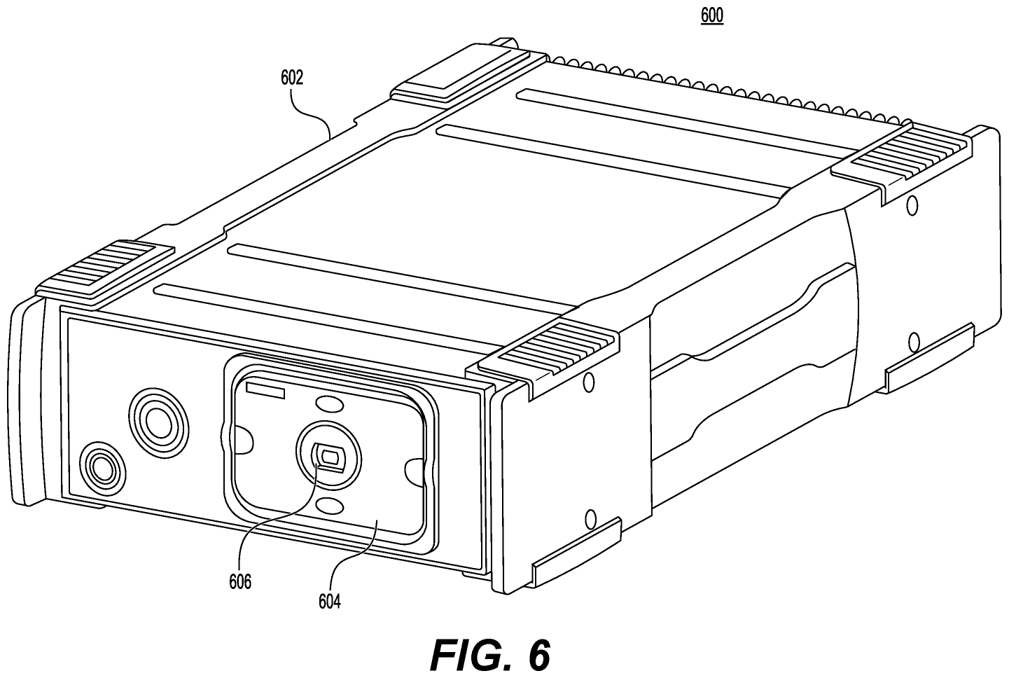

Various manners in which the controller 110 may operate are discussed in greater detail with respect to the method 500 depicted in FIG. 5. Particularly, FIG. 5 illustrates a flow diagram of a method 500 for inspecting a DUT, such as a terminating end of a fiber-optic cable, according to an example of the present disclosure. It should be understood that the method 500 may include additional operations and that some of the operations described therein may be removed and/or modified without departing from the scope of the method 500. The description of the method 500 is made with reference to the features depicted in FIGS. 1-4 for purposes of illustration.

At block 502, the controller 110 may cause an imager 108 to capture a first image of a DUT through a first objective assembly 114 having a first magnification level. In some examples, the controller 110 may cause the imager 108 to capture the first image in response to receipt of an instruction from a user to initiate an inspection operation. In some examples, the controller 110 may receive a signal from a sensor in or on the DUT interface 112 that may be triggered when an adapter plate or a DUT is positioned in or on the DUT interface 112 and may initiate the inspection operation based on receipt of the signal. The sensor may be an optical sensor, a mechanical sensor, or the like.

In instances in which the first objective assembly 114 is positioned in front of the DUT interface 112, the controller 110 may cause the imager 108 to capture the first image without first causing the optical system 104, 300, 350 (and/or the DUT interface 112) and/or the objective switcher 124 to be moved such that light rays from the DUT are captured through the first objective assembly 114 and directed to the imager 108 as discussed above. However, in instances in which the first objective assembly 114 is not positioned in front of the DUT interface 112, the controller 110 may cause the panning actuator 120 to move the optical system 104 (and/or the DUT interface 112) such that the first objective assembly 114 is positioned in front of the DUT interface 112. In addition, the controller 110 may cause the objective switcher actuator 126 to move the objective switcher 124 to a first arrangement as shown in FIG. 3A to cause light rays from the first objective assembly 114 to be directed to the imager 108. Alternatively, the controller 110 may cause the first blocking/deflecting element 354 to prevent light from being directed back through the second objective assembly 116 and the second blocking/deflecting element 356 to cease blocking the first objective assembly 114 as shown in FIG. 3C.

As discussed herein, the controller 110 may also cause the illumination source 128 to output light rays 304 through the illumination tube 216 and to the first objective assembly 114. The light rays 304 may illuminate the DUT such that light may be reflected from the DUT and the reflected light may be directed back through the first objective assembly 114 and to the imager 108. The imager 108 may capture images of the DUT while the DUT is illuminated by the illumination source 128.

The controller 110 may also cause the autofocus motor 132 to vary the focus of the first objective assembly 114 and the imager 108 may capture images of the DUT at the various focus levels. In addition, or alternatively, the controller 110 may cause the scanning actuator 130 to scan the optical system 104 vertically such that the imager 108 may capture images of other areas of the DUT or other DUTs. In examples in which multiple images of different areas of the DUT or DUTs, the controller 110 may stitch the multiple images together to generate combination images.

At block 504, the controller 110 may analyze the first image to identify potential defects in or on the DUT. As the magnification level of the first objective assembly 114 may be relatively low, the defects identifiable in the first image may be relatively large defects. For instance, the defects may be cracks, gouges, or the like, in the DUT. As other examples, the defects may be a grouping of smaller defects that may be visible in the first image.

At block 506, the controller 110 may determine whether the DUT has passed or failed an optical inspection of the DUT. As discussed herein, to determine whether the DUT has passed or failed the optical inspection, the controller 110 may determine whether an identified defect exceeds (or multiple defects exceed) a predefined threshold, e.g., a size threshold, a count threshold, a position threshold, and/or the like. In these examples, the controller 110 may determine that the DUT has failed the inspection when the controller 110 determines that the defect exceeds the predefined threshold. The predefined threshold may be user-defined and may be based on historical data, testing, modelling, ad/or the like.

Based on a determination that the DUT has failed the inspection, at block 508, the controller 110 may end the inspection as indicated at block 508. Additionally, at block 510, the controller 110 may output an indication that the DUT has failed the inspection. A user may, in response to the indication, remove the DUT from the DUT interface 112 and may insert another DUT into the DUT interface 112 and the controller 110 may repeat blocks 502-506 on the other DUT.

However, based on a determination that the DUT has passed the optical inspection at block 506, at block 512, the controller 110 may cause a panning actuator 120 to position the DUT within a field of view of a second objective assembly 116 having a second magnification level. For instance, the controller 110 may cause the panning actuator 120 to pan the optical system 104 such that the second objective assembly 116 is positioned in front of the DUT interface 112. As another example, the controller 110 may cause the panning actuator 120 to pan the DUT interface 112 such that the DUT interface 112 is positioned in front of the second objective assembly 116.

In addition, at block 514, the controller 110 may cause light rays from the illumination source 128 to be directed to the DUT through the second objective assembly 116. For instance, the controller 110 may cause an objective switcher 124 to be switched to an arrangement in which light rays from the second objective assembly 116 are directed to the imager 108 as discussed herein with respect to FIG. 3B. Alternatively, the controller 110 may cause the first blocking/deflecting element 354 to be moved to an unblocking position and the second blocking/deflecting element 356 to be moved to a blocking/deflecting position as discussed herein with respect to FIG. 3D.

Moreover, at block 516, the controller 110 may cause the imager 108 to capture a second image of the DUT through the second objective assembly 116. In other words, the controller 110 may cause the optical system 104 and the objective switcher 124 in positions as shown in FIG. 3B such that the imager 108 may capture images of the DUT through the second objective assembly 116.

The controller 110 may cause the illumination source 128 to output light rays 304 through the illumination tube 216 and to the second objective assembly 116. The light rays 304 may illuminate the DUT such that light may be reflected from the DUT and the reflected light may be directed back through the second objective assembly 116 and to the imager 108. The imager 108 may capture images of the DUT while the DUT is illuminated by the illumination source 128.

The controller 110 may also cause the autofocus motor 132 to vary the focus of the second objective assembly 116 and the imager 108 may capture images of the DUT through the second objective assembly 116 at the various focus levels. In addition, or alternatively, the controller 110 may cause the scanning actuator 130 to scan the optical system 104 vertically such that the imager 108 may capture images of other areas of the DUT or other DUTs through the second objective assembly 116. In examples in which multiple images of different areas of the DUT or DUTs, the controller 110 may stitch the multiple images together to generate combination images.

Although not shown in FIG. 5, the controller 110 may analyze the images captured of the DUT through the second objective assembly 116. As the magnification level of the second objective assembly 116 may be relatively high, and specifically, higher than the magnification level of the first objective assembly 114, the defects identifiable in the second image may be relatively small defects. For instance, the defects may be scratches, dust particles, markings, or the like, in the DUT. As other examples, the defects may be a grouping of smaller defects that may be visible in the second image. The controller 110 may also determine whether the DUT has passed or failed an optical inspection of the DUT. As discussed herein, to determine whether the DUT has passed or failed the optical inspection, the controller 110 may determine whether an identified defect exceeds (or multiple defects exceed) a predefined threshold, e.g., a size threshold, a count threshold, a position threshold, and/or the like. In these examples, the controller 110 may determine that the DUT has failed the inspection when the controller 110 determines that the defect exceeds the predefined threshold. The predefined threshold may be user-defined and may be based on historical data, testing, modelling, and/or the like.

Based on a determination that the DUT has failed the inspection, the controller 110 may output an indication that the DUT has failed the inspection. A user may, in response to the indication, remove the DUT from the DUT interface 112 and may insert another DUT into the DUT interface 112 and the controller 110 may repeat blocks 502-516 on the other DUT. However, based on a determination that the DUT has passed the inspection, the controller 110 may output an indication that the DUT has passed the inspection. Following output of the indication, the DUT may be removed from the DUT interface 112 and another DUT may be inserted into the DUT interface 112 such that the other DUT may be inspected.

According to examples, the order in which the images captured through the first objective assembly 114 and the second objective assembly 116 may be flipped as compared to the order described with respect to the method 500. That is, a DUT may be inspected using images captured through the second objective assembly 116 prior to inspecting the DUT using images captured through the first objective assembly 114.

FIG. 6 shows a perspective view of an apparatus 600 for inspecting a DUT, according to an example of the present disclosure. The apparatus 600 may be equivalent to any of the apparatuses 100, 200 discussed herein. As shown, the apparatus may include a chassis 602 and a DUT interface 604, in which the DUT interface 604 may include an opening 606 through which a terminating end of a DUT may be inserted for inspection.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. An apparatus for inspecting a device under test (DUT), the apparatus comprising:
a chassis;
an optical system comprising:
a camera assembly;
a first objective assembly having a first magnification level;
a second objective assembly having a second magnification level; and
a DUT interface including an opening in the chassis through which an end of a DUT inserted into the opening of the DUT interface is selectively visible to one of the first objective assembly and the second objective assembly, wherein at least one of the DUT interface and the optical system is movable with respect to the other one of the DUT interface and the optical system.

2. The apparatus of claim 1, further comprising:
an objective switcher to switch between a first light path from the first objective assembly to the camera assembly and a second light path from the second objective assembly to the camera assembly.

3. The apparatus of claim 2, further comprising:
an illumination source to direct light rays toward the first objective assembly and the second objective assembly, wherein the objective switcher is to selectively direct the light rays to the first objective assembly or the second objective assembly.

4. The apparatus of claim 2, wherein the objective switcher comprises a mirror and wherein the optical system further comprises:
an objective switcher actuator to move the objective switcher between a first arrangement in which light from the first objective assembly is directed to the camera assembly through the first light path and a second arrangement in which light from the second objective assembly is directed to the camera assembly through the second light path.

5. The apparatus of claim 4, wherein the objective switcher is rotatable about a pivot axis and wherein the objective switcher actuator is to move the objective switcher between the first arrangement and the second arrangement by causing the objective switcher to rotate about the pivot axis.

6. The apparatus of claim 1, further comprising:
at least one of:
a panning actuator to selectively pan at least one of the optical system and the DUT interface between a first position in which the first objective assembly is adjacent to the DUT interface and a second position in which the second objective assembly is adjacent to the DUT interface; or
a scanning actuator to selectively scan at least one of the optical system and the DUT interface vertically with respect to the other one of the optical system and the DUT interface.

7. The apparatus of claim 6, wherein the scanning actuator is to cause the first objective assembly and the second objective assembly to rotate about an axis.

8. The apparatus of claim 1, further comprising:
a beam splitter;
a reflective surface; and
an illumination source to output light rays toward the beam splitter, wherein the beam splitter is positioned to reflect a portion of the light rays toward the second objective assembly and another portion of the light rays toward the reflective surface, and wherein the reflective surface is to direct the another portion of the light rays toward the first objective assembly.

9. The apparatus of claim 8, further comprising:
a first blocking/deflecting element to selectively prevent light from the beam splitter from being reflected back toward an imager through the second objective assembly; and
a second blocking/deflecting element to selectively prevent light from the beam splitter from being reflected back toward the imager through the first objective assembly.

10. An apparatus for inspecting a terminating end of a fiber-optic cable, the apparatus comprising:
a chassis having a fiber-optic cable interface; and
an optical system housed within the chassis, the optical system comprising:
an imager to capture images;
a first objective assembly having a first magnification level;
a second objective assembly having a second magnification level;
a beam splitter; and
an illumination source to direct light rays to the beam splitter, wherein light rays directed to the beam splitter are to be directed to either or both of the first objective assembly and the second objective assembly, and
wherein at least one of the at least one of the fiber-optic cable interface and the optical system is movable with respect to the other one of the fiber-optic cable interface and the optical system to selectively position a fiber-optic cable inserted in the fiber-optic cable interface to be imaged in front of one of the first objective assembly and the second objective assembly.

11. The apparatus of claim 10, further comprising:
an objective switcher to selectively be switched between a first arrangement in which the imager captures images through the first objective assembly and a second arrangement in which the imager captures images through the second objective assembly, wherein the objective switcher is to selectively direct the light rays to the first objective assembly or the second objective assembly; and
an objective switcher actuator to move the objective switcher between the first arrangement and the second arrangement.

12. The apparatus of claim 11, wherein the objective switcher is rotatable about a pivot axis and wherein the objective switcher actuator is to move the objective switcher between the first arrangement and the second arrangement by causing the objective switcher to rotate about the pivot axis.

13. The apparatus of claim 10, further comprising:
at least one of:
a panning actuator to selectively pan at least one of the optical system and the fiber-optic cable interface between a first position in which the first objective assembly is adjacent to the fiber-optic cable interface and a second position in which the second objective assembly is adjacent to the fiber-optic cable interface; or
a scanning actuator to scan at least one of the optical system and the fiber-optic cable interface vertically with respect to the other one of the optical system and the fiber-optic cable interface.

14. The apparatus of claim 10, wherein the fiber-optic cable interface comprises a plurality of connections into which a plurality of fiber-optic cables are to be inserted into respective ones of the plurality of connections and wherein at least one of the fiber-optic cable interface and the optical system is movable with respect to the other one of the fiber-optic cable interface and the optical system to selectively position at least one of the plurality of connections adjacent to one of the first objective assembly and the second objective assembly.

15. The apparatus of claim 10, further comprising:
a reflective surface, wherein the beam splitter is positioned to reflect a portion of the light rays toward the second objective assembly and another portion of the light rays toward the reflective surface, and wherein the reflective surface is to direct the another portion of the light rays toward the first objective assembly;
a first blocking/deflecting element to selectively prevent light from the beam splitter from being reflected back toward the imager through the second objective assembly; and
a second blocking/deflecting element to selectively prevent light from the beam splitter from being reflected back toward the imager through the first objective assembly.

16. The apparatus of claim 10, further comprising:
a controller to:
cause the imager to capture a first image of the terminating end of the fiber-optic cable through the first objective assembly;
determine whether the fiber-optic cable has passed or failed an inspection;
based on a determination that the fiber-optic cable has passed the inspection,
cause the second objective assembly to be adjacent to the fiber-optic cable interface; and
cause the imager to capture a second image of the terminating end of the fiber-optic cable through the second objective assembly.

17. The apparatus of claim 16, wherein the controller is further to:
based on a determination that the fiber-optic cable has failed the inspection, stop inspection of the fiber-optic cable and output a notification that the fiber-optic cable has failed the inspection.

18. A method of optically inspecting a device under test (DUT), the method comprising:
causing, by a controller, an imager to capture a first image of the DUT through a first objective assembly having a first magnification level;
determining, by the controller, whether the DUT has passed or failed an optical inspection of the DUT;
based on a determination that the DUT has passed the optical inspection,
causing, by the controller, the DUT to be positioned within a field of view of a second objective assembly having a second magnification level;
causing, by the controller, light rays to be directed through the second objective assembly and for light rays reflected from the DUT to be directed through the second objective assembly to the imager; and
causing, by the controller, the imager to capture a second image of the DUT through the second objective assembly.

19. The method of claim 18, further comprising:
based on a determination that the DUT has failed the inspection,
stopping inspection of the DUT; and
outputting a notification that the DUT has failed the inspection.

20. The method of claim 18, further comprising:
causing a scanning actuator to scan the first objective assembly and the second objective assembly vertically about an axis; and
causing the imager to capture a third image of the DUT through one of the first objective assembly and the second objective assembly while the first objective assembly and the second objective assembly are in the vertically scanned position.
